(19) United States
(12) Patent Application Publication
(10) Pub. No.: US 2018/0204435 A1
(43) Pub. Date: Jul. 19, 2018

(54) Determination Of A Lead Time For The Replacement Of An Optical Smoke Detector As A Function Of Its Contamination

(71) Applicant: Siemens Schweiz AG, Zuerich (CH)

(72) Inventors: Horst Hilsinger, Zug (CH); Joachim Langenscheid, Zürich (CH)

(73) Assignee: Siemens Schweiz AG, Zuerich (CH)

(21) Appl. No.: 15/853,744

(22) Filed: Dec. 23, 2017

(30) Foreign Application Priority Data
Jan. 13, 2017 (DE) 10 2017 200 544.0

(51) Int. Cl. G08B 17/107; G08B 29/04; G08B 25/10; G01N 21/88; H04W 4/38; G06Q 10/00

(52) U.S. Cl. CPC G08B 17/107; G08B 29/043; G06Q 10/20; G01N 21/88; H04W 4/38; G08B 25/10

(57) ABSTRACT

The present disclosure relates to smoke detectors. The teachings thereof may be embodied in a method for the determination of the level of contamination of an optical smoke detector and/or a system for the determination of the level of contamination of an optical smoke detector. For example, a method for the determination of a lead time for the replacement of an optical smoke detector, may include: calculating a current value for the level of contamination (VG) of the optical smoke detector from a scattered light signal of the optical smoke detector in the absence of detectable smoke; using the current value for the level of contamination when compensating for the level of contamination of the particular optical smoke detector; storing further values calculated for the level of contamination continually in a cloud infrastructure; calculating the lead time by means of trend analysis based on the stored values for the level of contamination; and transmitting the values for the level of contamination by the particular optical smoke detector to the cloud infrastructure over an Internet connection.

### CROSS-REFERENCE TO RELATED APPLICATIONS

This application claims priority to DE Application No. 102017200544.0 filed Jan. 13, 2017, the contents of which are hereby incorporated by reference in their entirety.

### TECHNICAL FIELD

The present disclosure relates to smoke detectors. The teachings thereof may be embodied in a method for the determination of the level of contamination of an optical smoke detector and/or a system for the determination of the level of contamination of an optical smoke detector.

### BACKGROUND

Smoke detectors become contaminated during their operational life by dust and other particles even absent exposure to smoke. After a certain time period, a compensation time period, during which the influence of the contamination on its optical smoke detection can be compensated for, the smoke detector reacts more sensitively. This leads to greater probability of a false alarm signal being emitted. The end of the compensation time period may be signaled in the form of a warning message, or technical information message (Drift), to the fire alarm control panel, although usually not to a linked remote service center. After a second, higher level of contamination is reached that exceeds the first level of contamination (at the end of the compensation time period) an error message is issued to the fire alarm control panel. In such a case, immediate replacement of the smoke detector by a local service technician is required.

Typically, a service technician is required to replace a smoke detector if either an unforeseeable fault is present or if a predefined period of operation of the smoke detector has elapsed. In the second case, replacement of the smoke detector is not even necessary if the smoke detector is only slightly contaminated. Such replacement incurs unnecessary additional costs.

### SUMMARY

In some embodiments, a method for the determination of a lead time (TP) for the replacement of an optical smoke detector (10) may include: calculating a current value for the level of contamination (VG) of the optical smoke detector (10) from a scattered light signal of the optical smoke detector (10), in particular in the absence of detectable smoke. The current value for the level of contamination (VG) is used when compensating for the level of contamination of the particular optical smoke detector (10). Further values calculated for the level of contamination (VG) are continually stored in a cloud infrastructure (INF). The lead time (TP) is calculated by means of trend analysis based on the stored values for the level of contamination (VG). The values for the level of contamination (VG) are transmitted by the particular optical smoke detector (10) over a wired detector line (ML) to an overriding fire alarm control panel (P) and from there on to the cloud infrastructure (INF) over an Internet connection (INT).

In some embodiments, a method for the determination of a lead time (TP) for the replacement of an optical smoke detector (10) might include calculating a current value for the level of contamination (VG) of the optical smoke detectors (10) from a scattered light signal of the optical smoke detector (10), in particular in the absence of detectable smoke. The current value for the level of contamination (VG) is used when compensating for the contamination of the particular optical smoke detector (10). Other values calculated for the level of contamination (VG) are continually stored in a cloud infrastructure (INF). The lead time (TP) is calculated by means of trend analysis based on the stored values for the level of contamination (VG). The values for the level of contamination (VG) are transmitted by a particular IoT enabled optical smoke detector (10) directly to the cloud infrastructure (INF) over an Internet connection (INT).

In some embodiments, the lead time (TP) calculated represents the interpolated point in time (t₂) at which the value of the level of contamination (VG) exceeds a first threshold (DG) at which a service message is issued to an overriding fire alarm control panel (P) for the optical smoke detector (10).

In some embodiments, the method is used in a multiplicity of optical smoke detectors (10), wherein the respective further values (VGn) for the level of contamination (VG) are stored centrally for all optical smoke detectors (10), in particular in the same cloud infrastructure (INF), and wherein an individual lead time (TP) is calculated for the particular optical smoke detector (10).

In some embodiments, the computation of the lead time (TP) is in each case carried out by a cloud application (APP) of the cloud infrastructure (INF).

In some embodiments, the lead times (VP) calculated for the replacement of the respective optical smoke detectors (10) are transmitted over an Internet connection to a mobile device, in particular a smartphone, and are displayed there.

In some embodiments, a system for the determination of a lead time (TP) for the replacement of an optical smoke detector (10) may include: a multiplicity of optical smoke detectors (10), each of which is configured to calculate, from a scattered light signal, a current value for the level of contamination (VG), in particular in the absence of detectable smoke, and is configured to use this current value when compensating for the contamination; a fire alarm control panel (P) that is connected to a detector line (ML), wherein the multiplicity of optical smoke detectors (10) is connected to the detector line (ML); and a cloud infrastructure (INF) with a memory (DB) for the continual storage of other values calculated for the level of contamination (VG) of a particular optical smoke detector (10) and with an electronic processing unit for executing a cloud application (APP), in order to calculate a particular lead time (TP) by means of trend analysis based on the stored values (VGn) for the level of contamination (VG) of the particular smoke detector (10). The smoke detectors (10) are configured continually to transmit a value for the level of contamination (VG) to the fire alarm control panel (P). The fire alarm control panel (P) is configured to transmit the respective values (VGn) for the level of contamination to the cloud infrastructure (INF), in particular to the memory (DB) of the cloud infrastructure (INF), over an Internet connection (INT).

In some embodiments, the particular lead time (TP) calculated represents the interpolated point in time (t₂) at which the particular value of the level of contamination (VG) exceeds a first threshold (DG) at which a service message is issued to an overriding fire alarm control panel (P) for the optical smoke detector (10).

In some embodiments, a system for the determination of a lead time (TP) for the replacement of an optical smoke detector (10) may include: a multiplicity of IoT-enabled optical smoke detectors (10), each of which is configured to calculate, from a scattered light signal, a current value for the level of contamination (VG), in particular in the absence of detectable smoke, to use this current value when compensating for the contamination, and continually to transmit other values (VGn) calculated for a level of contamination (VG) directly to a cloud infrastructure (INF) over an Internet connection (INT), and a cloud infrastructure (INF) with a memory (DB) for the continual storage of the other values calculated for the level of contamination (VG) of a particular smoke detector (10) and with an electronic processing unit for executing a cloud application (APP), in order to calculate a particular lead time (TP) by means of trend analysis based on the stored values (VGn) for the level of contamination (VG) of the particular smoke detector (10).

In some embodiments, the particular lead time (TP) calculated represents the interpolated point in time (t₂) at which the particular value of the level of contamination (VG) exceeds a first threshold (DG) at which a service message is then transmitted by the cloud application (APP) over an Internet connection (INT) to a mobile device, in particular a smartphone, and is displayed there.

### BRIEF DESCRIPTION OF THE FIGURES

Some example embodiments are explained using the following figures as examples:

FIG. 1 shows an example of an optical detection chamber 1, which is also called Labyrinth.

FIG. 2 shows a graph G of the level of contamination VG over time t.

FIG. 3 shows an example of the calculation of the lead time TP by means of a cloud application APP of a cloud infrastructure INF.

### DETAILED DESCRIPTION

In some embodiments, the level of contamination of the smoke detector is calculated within the smoke detector itself. The photosensor of the smoke detector detects a part of the emitted light as a function of the level of contamination within the optical detection chamber (Labyrinth). On the basis of the level of contamination this value can be calculated by a processor-supported control unit (microcontroller) of the smoke detector. To this end, usually in the absence of detectable smoke, i.e. at a low level of scattered light, the so-called basic impulse is measured that originates from the scattered light on the walls of the optical detection chamber. The individual percentage degree of contamination, or another numerical value representing the level of contamination in a smoke detector, can then be read via a fire alarm control panel and from there transmitted to a linked remote service center. This can take place over a web server, for example, or over a cloud infrastructure. In future it will be possible for so-called IoT fire detectors (IoT stands for Internet of Things) also to be directly connected to the same infrastructure, i.e. electronically linked to it.

Cloud based software applications may be used to calculate the maximal operational life of every smoke detector on the basis of historic trend values. Efficient service planning for installed smoke detectors is enabled on the basis of this information. By means of enhanced reality, i.e. so-called augmented reality, an individual inspection can be carried out locally by a service technician, for example by means of smart glasses (e.g. Google Glasses), and the service technician can then check the installed smoke detectors as he or she walks through the building.

Cloud infrastructure offers the required computing power and sufficient memory for the percentage values received for the level of contamination to be collected over the course of years and for an exact date for the replacement of each smoke detector to be calculated. At the same time, the computing power needed and the memory required for it can be scaled according to the number of smoke detectors. The cloud infrastructure can also provide the computing power to analyze a gigantic array of smoke detectors and extract information, e.g. for servicing intervals. This information can also be used for manufacturers' recommendations for the servicing of smoke detectors.

In some embodiments, the system includes analysis of the data on the level of contamination, e.g., in percentage values. A further aspect of the invention resides in so-called apps, i.e. applications for smartphones or other mobile communications terminals that enable so-called predictive maintenance, i.e. predictive service planning. These apps can be configured, or programmed, to display the particular replacement date of the smoke detector located in the vicinity or in a building. Similar smoke detector replacement dates that differ from one another only very slightly, such as for example by a week or a month, can be assigned to the same servicing date by means of the app as planning tool.

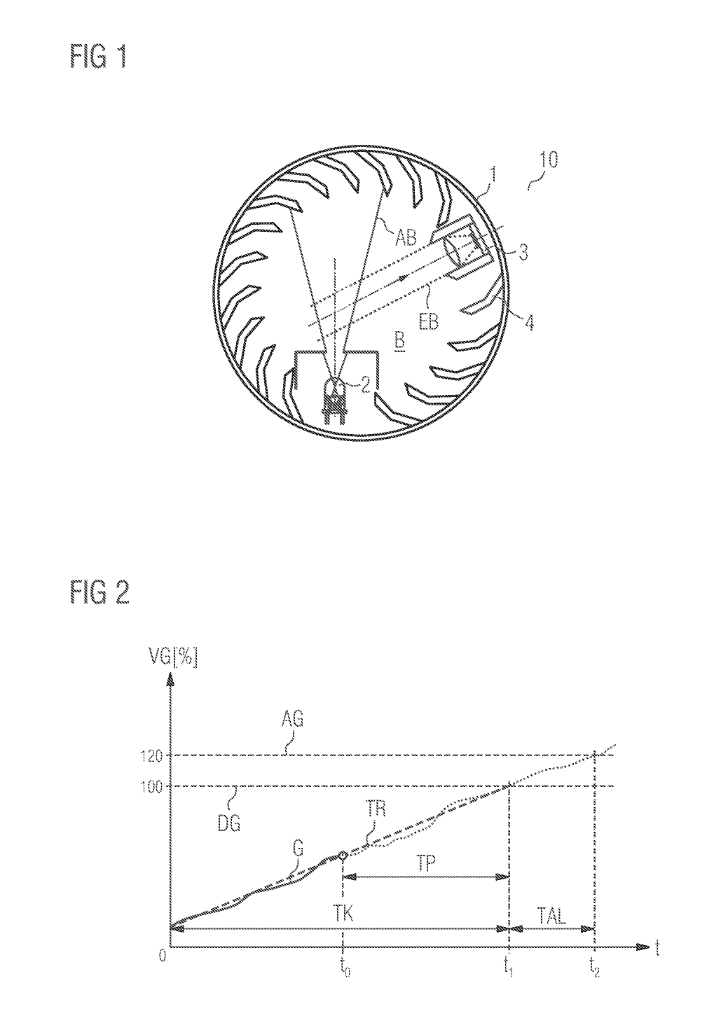

FIG. 1 shows an example of an optical detection chamber 1, which may be called Labyrinth. The optical smoke detection is based on the measurement of scattered light by means of a light emitter 2 and a photosensor 3. The blades, which are indicated by the reference number 4, and a floor and ceiling area, indicated by the letter B, of the Labyrinth 1, are subject to contamination over the course of time. AB is the light emitting area of the light emitter 2 and EB is the receiving area of the photosensor 3.

FIG. 2 shows a graph G of the level of contamination VG over time t. DG indicates a first threshold and AG a second threshold for the level of contamination VG. The graph G shows the increasing level of contamination of an optical smoke detector over time t. At the current time t₀ the point in time t₂ at which the first threshold DG might be reached is calculated from the stored historic values for the level of contamination.

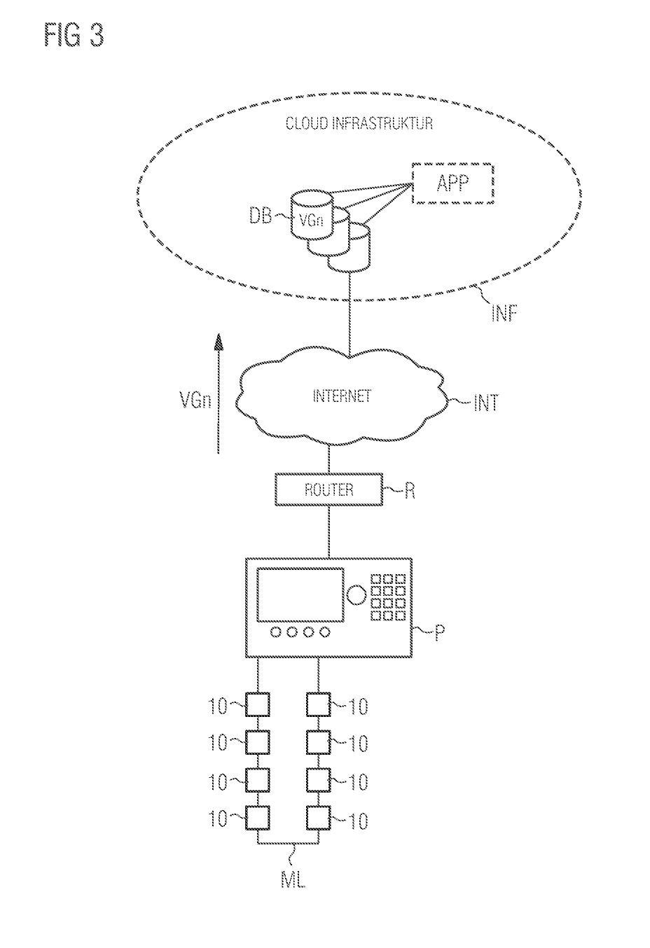

FIG. 3 shows an example of the calculation of the lead time TP by means of a cloud application APP of a cloud infrastructure INF. Each of the other values VGn for the level of contamination of the multiplicity of optical smoke detectors 10 shown is stored in a database DB of the cloud infrastructure INF. In the present example, each of the optical smoke detectors 10 transmits its values for the level of contamination to a fire alarm control panel P over a shared detector line ML. The fire alarm control panel P forwards these values VGn to the cloud infrastructure INF, or to an electronic control unit of the cloud infrastructure INF on which the cloud application APP is executed, over an Internet connection INT and an optional Router R, to calculate the particular individual lead time TP for each of the optical smoke detectors 10.

1. A method for the determination of a lead time for the replacement of an optical smoke detector, the method including:
calculating a current value for the level of contamination (VG) of the optical smoke detector from a scattered light signal of the optical smoke detector in the absence of detectable smoke;
using the current value for the level of contamination when compensating for the level of contamination of the particular optical smoke detector;
storing further values calculated for the level of contamination continually in a cloud infrastructure;
calculating the lead time by means of trend analysis based on the stored values for the level of contamination; and
transmitting the values for the level of contamination by the particular optical smoke detector to the cloud infrastructure over an Internet connection.

2. A method according to claim 1, wherein transmitting the values for the level of contamination including a particular IoT enabled optical smoke detector transmitting directly to the cloud infrastructure over an Internet connection.

3. The method as claimed in claim 1, wherein the lead time represents an interpolated point in time at which the value of the level of contamination exceeds a first threshold; and
further comprising sending a service message to an overriding fire alarm control panel for the optical smoke detector at the calculated lead time.

4. The method as claimed in claim 1, further comprising applying the method to a multiplicity of optical smoke detectors;
storing the respective further values for the level of contamination centrally for all optical smoke detectors in the same cloud infrastructure; and
calculating an individual lead time for the particular optical smoke detector.

5. The method as claimed in claim 1, further comprising calculating the lead time in each case by a cloud application of the cloud infrastructure.

6. The method as claimed in claim 1, further comprising transmitting the lead times calculated for the replacement of the respective optical smoke detectors over an Internet connection to a mobile device.

7. A smoke detector system comprising:
a multiplicity of optical smoke detectors;
each optical smoke detector configured to calculate, from a scattered light signal, a current value for a respective level of contamination in the absence of detectable smoke and to use this current value when compensating for the contamination;
a cloud infrastructure having a memory for continual storage of other values calculated for the level of contamination of a particular optical smoke detector and an electronic processing unit for executing a cloud application;
wherein the cloud application calculates a particular lead time by trend analysis based on the stored values for the level of contamination of the particular smoke detector.

8. The system as claimed in claim 7, wherein the particular lead time calculated represents the interpolated point in time at which the particular value of the level of contamination exceeds a first threshold at which a service message is issued to an overriding fire alarm control panel for the optical smoke detector.

9. The system as claimed in claim 7, wherein the multiplicity of optical smoke detectors are all IoT-enabled and communicate with the cloud infrastructure over the Internet.

10. The system as claimed in claim 7, wherein the particular lead time calculated represents an interpolated point in time at which the particular value of the level of contamination exceeds a first threshold at which a service message is then transmitted by the cloud application over an Internet connection to a mobile device.

11. A method according to claim 1, wherein transmitting the values for the level of contamination includes a particular optical smoke detector transmitting over a wired detector line to an overriding fire alarm control panel and from there on to the Internet.

12. The system as claimed in claim 7, further comprising:
a fire alarm control panel connected to a detector line in communication with the multiplicity of optical smoke detectors;
wherein the smoke detectors transmit a value for the level of contamination to the fire alarm control panel and the fire alarm control panel communicates over the Internet.
